(19) United States
(12) Patent Application Publication
(10) Pub. No.: US 2004/0006628 A1
(43) Pub. Date: Jan. 8, 2004

(54) Systems and methods for providing real-time alerting

(76) Inventors: Scott Shepard, Waltham, MA (US); Daniel Kiecza, Cambridge, MA (US); Francis G. Kubala, Boston, MA (US); Amit Srivastava, Waltham, MA (US)

Correspondence Address: Leonard C. Suchyta, c/o Christian Andersen, Verizon Corporate Services Group Inc., 600 Hidden Ridge, HQE03H01, Irving, TX, 75038, US

(21) Appl. No.: 10/610,560

(22) Filed: Jul. 2, 2003

Related U.S. Application Data
(60) Provisional application No. 60/394,064, filed on Jul. 3, 2002.
(60) Provisional application No. 60/394,082, filed on Jul. 3, 2002.
(60) Provisional application No. 60/419,214, filed on Oct. 17, 2002.

(51) Int. Cl. G06F 15/16

(52) U.S. Cl. 709/228

(57) ABSTRACT

A system alerts a user of detection of an item of interest in real time. The system receives a user profile that relates to the item of interest. The system obtains real time data corresponding to information created in multiple media formats. The system determines the relevance of the real time data to the item of interest based on the user profile and alerts the user when the real time data is determined to be relevant.

### RELATED APPLICATION

This application claims priority under 35 U.S.C. §119 based on U.S. Provisional Application Nos. 60/394,064 and 60/394,082, filed Jul. 3, 2002, and Provisional Application No. 60/419,214, filed Oct. 17, 2002, the disclosures of which are incorporated herein by reference.

This application is related to U.S. patent application, Ser. No. ______ (Docket No. 02-4026), entitled, “Systems and Methods for Providing Online Event Tracking,” filed concurrently herewith and incorporated herein by reference.

### GOVERNMENT CONTRACT

The U.S. Government may have a paid-up license in this invention and the right in limited circumstances to require the patent owner to license others on reasonable terms as provided for by the terms of Contract No. 2001*5651600*000, awarded by the Office of Advanced Information Technology.

### BACKGROUND OF THE INVENTION

1. Field of the Invention

The present invention relates generally to multimedia environments and, more particularly, to systems and methods for providing real-time alerting when audio, video, or text documents of interest are created.

2. Description of Related Art

With the ever-increasing number of data producers throughout the word, such as audio broadcasts, video broadcasts, news streams, etc., it is getting harder to determine when information relevant to a topic of interest is created. One reason for this is that the data exists in many different formats and in many different languages.

The need to be alerted of the occurrence of relevant information takes many forms. For example, disaster relief teams may need to be alerted as soon as a disaster occurs. Stock brokers and fund managers may need to be alerted when certain company news is released. The United States Defense Department may need to be alerted, in real time, of threats to national security. Company managers may need to be alerted when people in the field identify certain problems. These are but a few examples of the need for real-time alerting.

A conventional approach to real-time alerting requires human operators to constantly monitor audio, video, and/or text sources for information of interest. When this information is detected, the human operator alerts the appropriate people. There are several problems with this approach. For example, such an approach would require a rather large work force to monitor the multimedia sources, any of which can broadcast information of interest at any time of the day and any day of the week. Also, human-performed monitoring may result in an unacceptable number of errors when, for example, information of interest is missed or the wrong people are notified. The delay in notifying the appropriate people may also be unacceptable.

As a result, there is a need for an automated real-time alerting system that monitors multimedia broadcasts and alerts one or more users when information of interest is detected.

### SUMMARY OF THE INVENTION

Systems and methods consistent with the present invention address this and other needs by providing real-time alerting that monitors multimedia broadcasts against a user-provided profile to identify information of interest. The systems and methods alert one or more users using one or more alerting techniques when information of interest is identified.

In one aspect consistent with the principles of the invention, a system that alerts a user of detection of an item of interest in real time is provided. The system receives a user profile that relates to the item of interest. The system obtains real time data corresponding to information created in multiple media formats. The system determines the relevance of the real time data to the item of interest based on the user profile and alerts the user when the real time data is determined to be relevant.

In another aspect consistent with the principles of the invention, a real-time alerting system is provided. The system includes collection logic and notification logic. The collection logic receives real time data. The real time data includes textual representations of information created in multiple media formats. The notification logic obtains a user profile that identifies one or more subjects of data of which a user desires to be notified and determines the relevance of the real time data received by the collection logic to the one or more subjects based on the user profile. The notification logic sends an alert to the user when the real time data is determined to be relevant.

In yet another aspect consistent with the principles of the invention, an alerting system is provided. The system includes one or more audio indexers and alert logic. The one or more audio indexers are configured to capture real time audio broadcasts and transcribe the audio broadcasts to create transcriptions. The alert logic is configured to receive a user profile that identifies one or more topics of which a user desires to be notified and receive the transcriptions from the one or more audio indexers. The alert logic is further configured to determine the relevance of the transcriptions to the one or more topics based on the user profile and alert the user when one or more of the transcriptions are determined relevant.

In a further aspect consistent with the principles of the invention, an alerting system is provided. The system includes one or more video indexers and alert logic. The one or more video indexers are configured to capture real time video broadcasts and transcribe audio from the video broadcasts to create transcriptions. The alert logic is configured to receive a user profile that identifies one or more topics of which a user desires to be notified and receive the transcriptions from the one or more video indexers. The alert logic is further configured to determine the relevance of the transcriptions to the one or more topics based on the user profile and alert the user when one or more of the transcriptions are determined to be relevant.

In another aspect consistent with the principles of the invention, an alerting system is provided. The system includes one or more text indexers and alert logic. The one or more text indexers are configured to receive real time text streams. The alert logic is configured to receive a user profile that identifies one or more topics of which a user desires to be notified and receive the text streams from the one or more text indexers. The alert logic is further configured to determine the relevance of the text streams to the one or more topics based on the user profile, and alert the user when one or more of the text streams are determined to be relevant.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram of a system in which systems and methods consistent with the present invention may be implemented;

FIGS. 2A-2C are exemplary diagrams of the multimedia sources of FIG. 1 according to an implementation consistent with the principles of the invention;

FIG. 3 is an exemplary diagram of an audio indexer of FIG. 1;

FIG. 4 is a diagram of a possible output of the speech recognition logic of FIG. 3;

FIG. 5 is a diagram of a possible output of the story segmentation logic of FIG. 3;

FIG. 6 is an exemplary diagram of the alert logic of FIG. 1 according to an implementation consistent with the principles of the invention; and

FIGS. 7 and 8 are flowcharts of exemplary processing for notifying a user of an item of interest in real time according to an implementation consistent with the principles of the invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Systems and methods consistent with the present invention provide mechanisms for monitoring multimedia broadcasts against a user-provided profile to identify items of interest. The systems and methods provide real-time alerting to one or more users using one of a number of alerting techniques when an item of interest is identified.

### Exemplary System

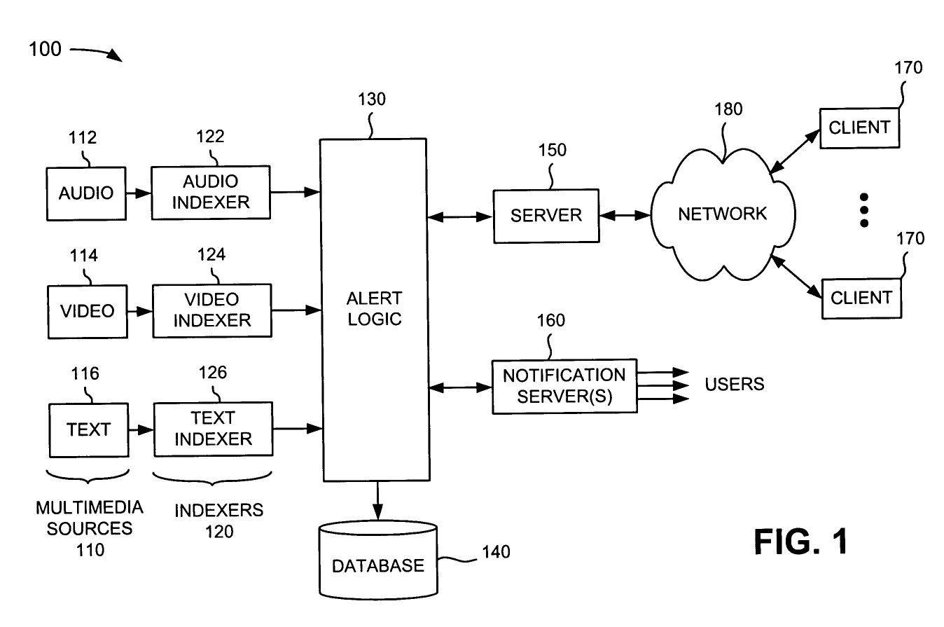

FIG. 1 is a diagram of an exemplary system 100 in which systems and methods consistent with the present invention may be implemented. System 100 may include multimedia sources 110, indexers 120, alert logic 130, database 140, and servers 150 and 160 connected to clients 170 via network 180. Network 180 may include any type of network, such as a local area network (LAN), a wide area network (WAN) (e.g., the Internet), a public telephone network (e.g., the Public Switched Telephone Network (PSTN)), a virtual private network (VPN), or a combination of networks. The various connections shown in FIG. 1 may be made via wired, wireless, and/or optical connections.

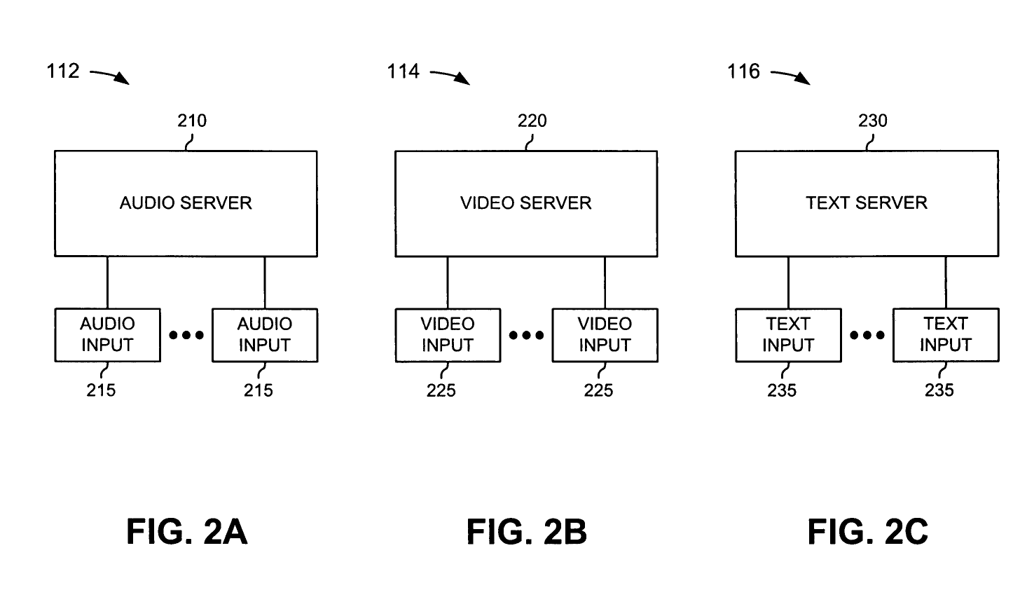

Multimedia sources 110 may include audio sources 112, video sources 114, and text sources 116. FIGS. 2A-2C are exemplary diagrams of audio sources 112, video sources 114, and text sources 116, respectively, according to an implementation consistent with the principles of the invention.

FIG. 2A illustrates an audio source 112. In practice, there may be multiple audio sources 112. Audio source 112 may include an audio server 210 and one or more audio inputs 215. Audio input 215 may include mechanisms for capturing any source of audio data, such as radio, telephone, and conversations, in any language. There may be a separate audio input 215 for each source of audio. For example, one audio input 215 may be dedicated to capturing radio signals; another audio input 215 may be dedicated to capturing conversations from a conference; and yet another audio input 215 may be dedicated to capturing telephone conversations. Audio server 210 may process the audio data, as necessary, and provide the audio data, as an audio stream, to indexers 120. Audio server 210 may also store the audio data.

FIG. 2B illustrates a video source 114. In practice, there may be multiple video sources 114. Video source 114 may include a video server 220 and one or more video inputs 225. Video input 225 may include mechanisms for capturing any source of video data, with possibly integrated audio data in any language, such as television, satellite, and a camcorder. There may be a separate video input 225 for each source of video. For example, one video input 225 may be dedicated to capturing television signals; another video input 225 may be dedicated to capturing a video conference; and yet another video input 225 may be dedicated to capturing video streams on the Internet. Video server 220 may process the video data, as necessary, and provide the video data, as a video stream, to indexers 120. Video server 220 may also store the video data.

FIG. 2C illustrates a text source 116. In practice, there may be multiple text sources 116. Text source 116 may include a text server 230 and one or more text inputs 235. Text input 235 may include mechanisms for capturing any source of text, such as e-mail, web pages, newspapers, and word processing documents, in any language. There may be a separate text input 235 for each source of text. For example, one text input 235 may be dedicated to capturing news wires; another text input 235 may be dedicated to capturing web pages; and yet another text input 235 may be dedicated to capturing e-mail. Text server 230 may process the text, as necessary, and provide the text, as a text stream, to indexers 120. Text server 230 may also store the text.

Returning to FIG. 1, indexers 120 may include one or more audio indexers 122, one or more video indexers 124, and one or more text indexers 126. Each of indexers 122, 124, and 126 may include mechanisms that receive data from multimedia sources 110, process the data, perform feature extraction, and output analyzed, marked up, and enhanced language metadata. In one implementation consistent with the principles of the invention, indexers 122-126 include mechanisms, such as the ones described in John Makhoul et al., “Speech and Language Technologies for Audio Indexing and Retrieval,” Proceedings of the IEEE, Vol. 88, No. 8, August 2000, pp. 1338-1353, which is incorporated herein by reference.

Indexer 122 may receive an input audio stream from audio sources 112 and generate metadata therefrom. For example, indexer 122 may segment the input stream by speaker, cluster audio segments from the same speaker, identify speakers known to data analyzer 122, and transcribe the spoken words. Indexer 122 may also segment the input stream based on topic and locate the names of people, places, and organizations. Indexer 122 may further analyze the input stream to identify the time at which each word is spoken. Indexer 122 may include any or all of this information in the metadata relating to the input audio stream.

Indexer 124 may receive an input video stream from video sources 122 and generate metadata therefrom. For example, indexer 124 may segment the input stream by speaker, cluster video segments from the same speaker, identify speakers by name or gender, identify participants with face recognition, and transcribe the spoken words. Indexer 124 may also segment the input stream based on topic and locate the names of people, places, and organizations. Indexer 124 may further analyze the input stream to identify the time at which each word is spoken. Indexer 124 may include any or all of this information in the metadata relating to the input video stream.

Indexer 126 may receive an input text stream or file from text sources 116 and generate metadata therefrom. For example, indexer 126 may segment the input stream/file based on topic and locate the names of people, places, and organizations. Indexer 126 may further analyze the input stream/file to identify when each word occurs (possibly based on a character offset within the text). Indexer 126 may also identify the author and/or publisher of the text. Indexer 126 may include any or all of this information in the metadata relating to the input text stream/file.

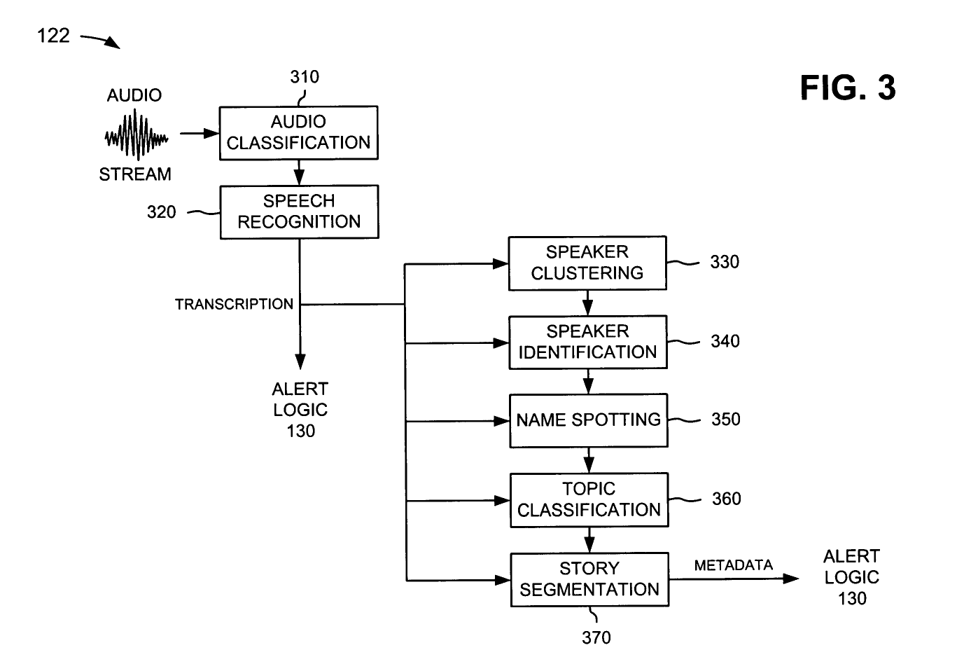

FIG. 3 is an exemplary diagram of indexer 122. Indexers 124 and 126 may be similarly configured. Indexers 124 and 126 may include, however, additional and/or alternate components particular to the media type involved.

As shown in FIG. 3, indexer 122 may include audio classification logic 310, speech recognition logic 320, speaker clustering logic 330, speaker identification logic 340, name spotting logic 350, topic classification logic 360, and story segmentation logic 370. Audio classification logic 310 may distinguish speech from silence, noise, and other audio signals in an input audio stream. For example, audio classification logic 310 may analyze each 30 second window of the input stream to determine whether it contains speech. Audio classification logic 310 may also identify boundaries between speakers in the input stream. Audio classification logic 310 may group speech segments from the same speaker and send the segments to speech recognition logic 320.

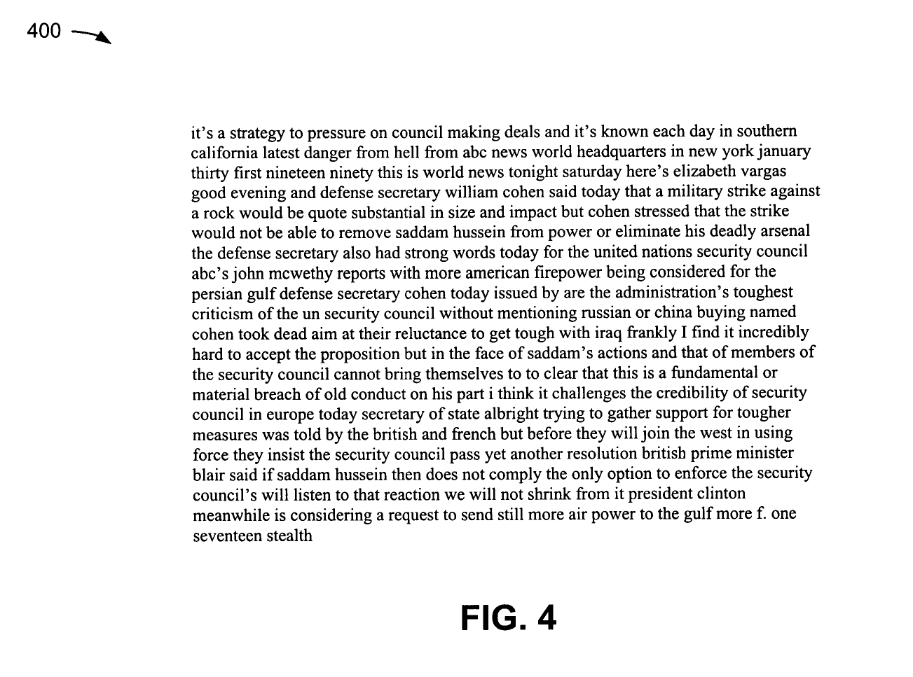

Speech recognition logic 320 may perform continuous speech recognition to recognize the words spoken in the segments it receives from audio classification logic 310. Speech recognition 320 logic may generate a transcription of the speech. FIG. 4 is an exemplary diagram of a transcription 400 generated by speech recognition logic 320. Transcription 400 may include an undifferentiated sequence of words that corresponds to the words spoken in the segment. Transcription 400 contains no linguistic data, such as periods, commas, etc.

Returning to FIG. 3, speech recognition logic 320 may send transcription data to alert logic 130 in real time (i.e., as soon as it is received by indexer 122, subject to minor processing delay). In other words, speech recognition logic 320 processes the input audio stream while it is occurring, not after it has concluded. This way, a user may be notified in real time of the detection of an item of interest (as will be described below).

Speaker clustering logic 330 may identify all of the segments from the same speaker in a single document (i.e., a body of media that is contiguous in time (from beginning to end or from time A to time B)) and group them into speaker clusters. Speaker clustering logic 330 may then assign each of the speaker clusters a unique label. Speaker identification logic 340 may identify the speaker in each speaker cluster by name or gender. Name spotting logic 350 may locate the names of people, places, and organizations in the transcription. Name spotting logic 350 may extract the names and store them in a database. Topic classification logic 360 may assign topics to the transcription. Each of the words in the transcription may contribute differently to each of the topics assigned to the transcription. Topic classification logic 360 may generate a rank-ordered list of all possible topics and corresponding scores for the transcription.

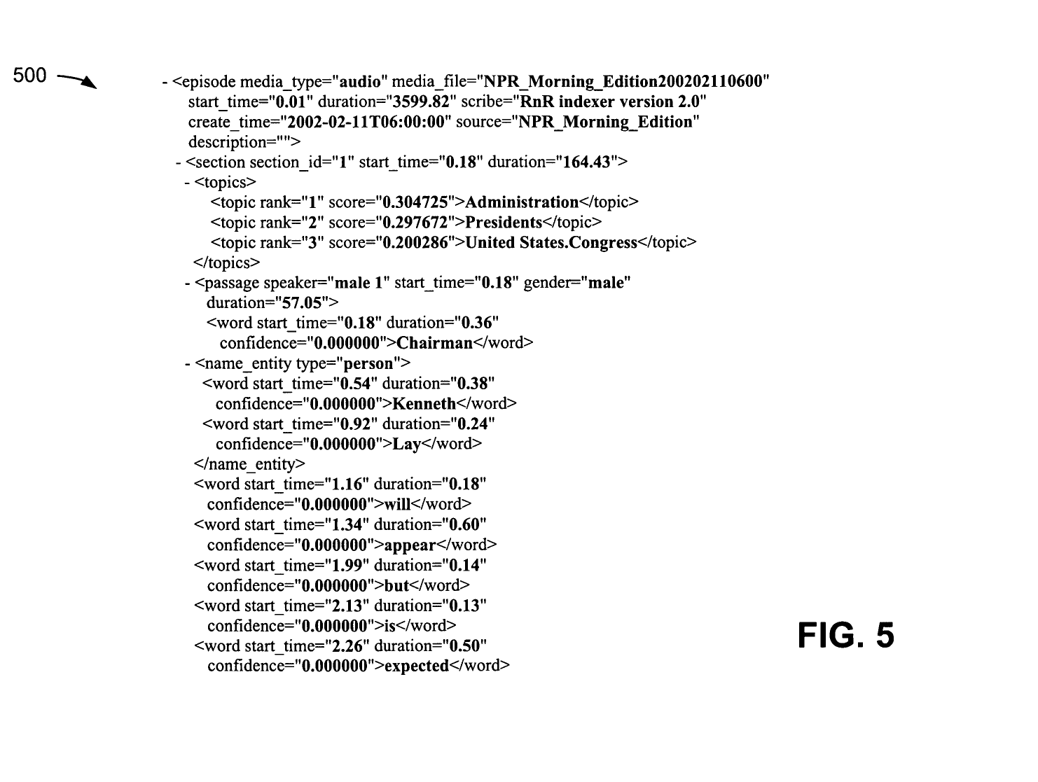

Story segmentation logic 370 may change the continuous stream of words in the transcription into document-like units with coherent sets of topic labels and all other document features generated or identified by other components of indexer 122. This information may constitute metadata corresponding to the input audio stream. FIG. 5 is a diagram of exemplary metadata 500 output from story segmentation logic 370. Metadata 500 may include information regarding the type of media involved (audio) and information that identifies the source of the input stream (NPR Morning Edition). Metadata 500 may also include data that identifies relevant topics, data that identifies speaker gender, and data that identifies names of people, places, or organizations. Metadata 500 may further include time data that identifies the start and duration of each word spoken. Story segmentation logic 370 may output the metadata to alert logic 130.

Returning to FIG. 1, alert logic 130 maps real-time transcription data from indexers 120 to one or more user profiles. In an implementation consistent with the principles of the invention, a single alert logic 130 corresponds to multiple indexers 120 of a particular type (e.g., multiple audio indexers 122, multiple video indexers 124, or multiple text indexers 126) or multiple types of indexers 120 (e.g., audio indexers 122, video indexers 124, and text indexers 126). In another implementation, there may be multiple alert logic 130, such as one alert logic 130 per indexer 120.

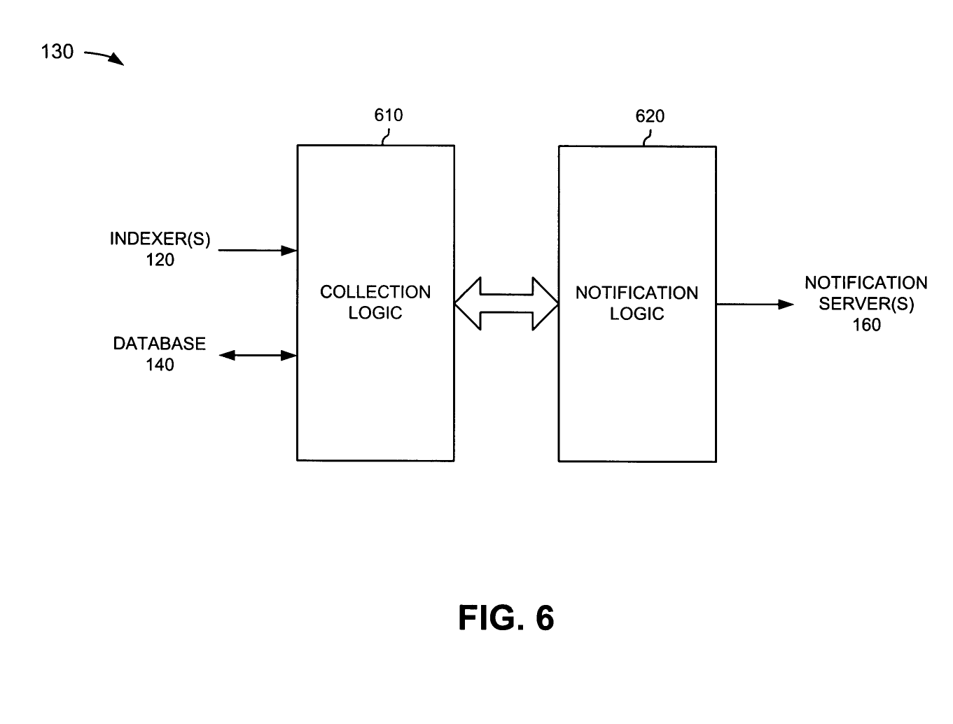

FIG. 6 is an exemplary diagram of alert logic 130 according to an implementation consistent with the principles of the invention. Alert logic 130 may include collection logic 610 and notification logic 620. Collection logic 610 may manage the collection of information, such as transcriptions and other metadata, from indexers 120. Collection logic 610 may store the collected information in database 140. Collection logic 610 may also provide the transcription data to notification logic 620.

Notification logic 620 may compare the transcription data to one or more user profiles. A user profile may include key words that may define subjects or topics of items (audio, video, or text) in which the user may be interested. It is important to note that the items are future items (i.e., ones that do not yet exist). Notification logic 620 may use the key words to determine the relevance of audio, video, and/or text streams received by indexers 120. The user profile is not limited to key words and may include anything that the user wants to specify for classifying incoming data streams. When notification logic 620 identifies an item that matches the user profile, notification logic 620 may generate an alert notification and send it to notification server(s) 160.

Returning to FIG. 1, database 140 may store a copy of all of the information received by alert logic 130, such as transcriptions and other metadata. Database 140 may, thereby, store a history of all information seen by alert logic 130. Database 140 may also store some or all of the original media (audio, video, or text) relating to the information. In order to maintain adequate storage space in database 140, it may be practical to expire (i.e., delete) information after a certain time period.

Server 150 may include a computer or another device that is capable of interacting with alert logic 130 and clients 170 via network 180. Server 150 may obtain user profiles from clients 170 and provide them to alert logic 130. Clients 170 may include personal computers, laptops, personal digital assistants, or other types of devices that are capable of interacting with server 150 to provide user profiles and, possibly, receive alerts. Clients 170 may present information to users via a graphical user interface, such as a web browser window.

Notification server(s) 160 may include one or more servers that transmit alerts regarding detected items of interest to users. A notification server 160 may include a computer or another device that is capable of receiving notifications from alert logic 130 and notifying users of the alerts. Notification server 160 may use different techniques to notify users. For example, notification server 160 may place a telephone call to a user, send an e-mail, page, instant message, or facsimile to the user, or use other mechanisms to notify the user. In an implementation consistent with the principles of the invention, notification server 160 and server 150 are the same server. In another implementation, notification server 160 is a knowledge base system.

The notification sent to the user may include a message that indicates that a relevant item has been detected. Alternatively, the notification may include a portion or the entire item of interest in its original format. For example, an audio or video signal may be streamed to the user or a text document may be sent to the user.

### Exemplary Processing

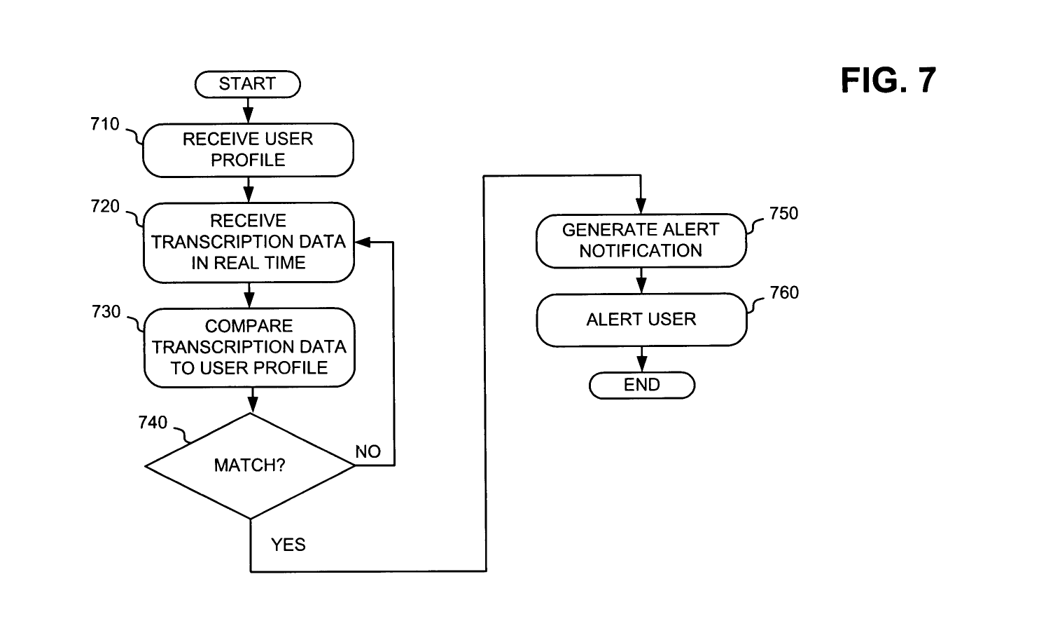

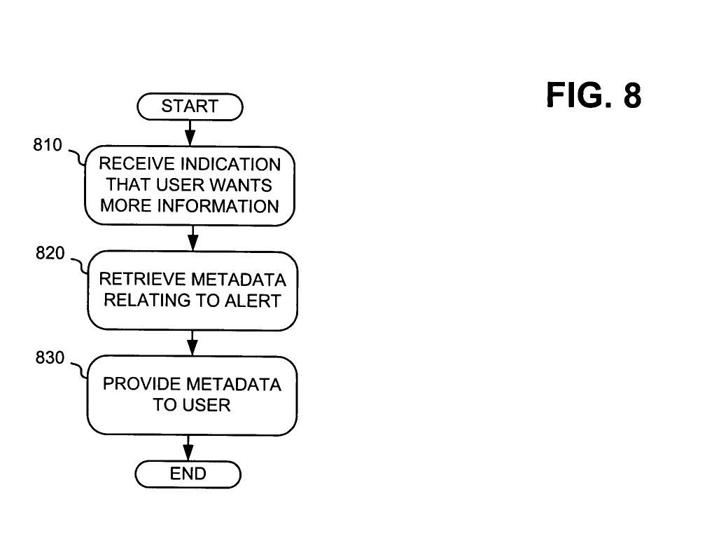

FIGS. 7 and 8 are flowcharts of exemplary processing for notifying a user of an item of interest in real time according to an implementation consistent with the principles of the invention. Processing may begin with a user generating a user profile. To do this, the user may access server 150 using, for example, a web browser on client 170. The user may interact with server 150 to provide one or more key words that relate to items of which the user would be interested in being notified in real time. In other words, the user desires to know at the time an item is created or broadcast that the item matches the user profile. The key words are just one mechanism by which the user may specify the items in which the user is interested. The user profile may also include information regarding the manner in which the user wants to be notified.

Alert logic 130 receives the user profile from server 150 and stores it for later comparisons to received transcription data (act 710) (FIG. 7). Alert logic 130 continuously receives transcription data in real time from indexers 120 (act 720). In the implementation where there is one alert logic 130 per indexer 120, then alert logic 130 may operate upon a single transcription at a time. In the implementation where this is one alert logic 130 for multiple indexers 120, then alert logic 130 may concurrently operate upon multiple transcriptions. In either case, alert logic 130 may store the transcription data in database 140.

Alert logic 130 may also compare the transcription data to the key words in the user profile (act 730). If there is no match (act 740), then alert logic 130 awaits receipt of next transcription data from indexers 120. If there is a match (act 740), however, alert logic 130 may generate an alert notification (act 750). The alert notification may identify the item (audio, video, or text) to which the alert pertains. This permits the user to obtain more information regarding the item if desired. Alert logic 130 may send the alert notification to notification server(s) 160. Alert logic 130 may identify the particular notification server 160 to use based on information in the user profile.

Notification server 160 may generate a notification based on the alert notification from alert logic 130 and send the notification to the user (act 760). For example, notification server 160 may place a telephone call to the user, send an e-mail, page, instant message, or facsimile to the user, or otherwise notify the user. In one implementation, the notification includes a portion or the entire item of interest.

While the above processing is occurring, the corresponding indexer 120 continues to process the item (audio, video, or text stream) to generate additional metadata regarding the item. Indexer 120 may send the metadata to alert logic 130 for storage in database 140.

At some point, the user may desire additional information regarding the alert. In this case, the user may provide some indication to client 170 of the desire for additional information. Client 170 may send this indication to alert logic 130 via server 150.

Alert logic 130 may receive the indication that the user desires additional information regarding the alert (act 810) (FIG. 8). In response, alert logic 130 may retrieve the metadata relating to the alert from database 140 (act 820). Alert logic 130 may then provide the metadata to the user (act 830).

If the user desires, the user may retrieve the original media corresponding to the metadata. The original media may be stored in database 140 along with the metadata, stored in a separate database possibly accessible via network 180, or maintained by one of servers 210, 220, or 230 (FIG. 2). If the original media is an audio or video document, the audio or video document may be streamed to client 170. If the original media is a text document, the text document may be provided to client 170.

### Conclusion

Systems and methods consistent with the present invention permit users to define user profiles and be notified, in real time, whenever new data is received that matches the user profiles. In this way, a user may be alerted as soon as relevant data occurs. This minimizes the delay between detection and notification.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. For example, while series of acts have been described with regard to the flowcharts of FIGS. 7 and 8, the order of the acts may differ in other implementations consistent with the principles of the invention.

Certain portions of the invention have been described as “logic” that performs one or more functions. This logic may include hardware, such as an application specific integrated circuit or a field programmable gate array, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the claims and their equivalents.

What is claimed is:

1. A method for alerting a user of detection of an item of interest in real time, comprising:
receiving a user profile that relates to the item of interest;
obtaining real time data corresponding to information created in a plurality of media formats;
determining relevance of the real time data to the item of interest based on the user profile; and
alerting the user when the real time data is determined relevant.

2. The method of claim 1, wherein the user profile includes one or more key words that define the item of interest.

3. The method of claim 2, wherein the determining relevance of the real time data includes:
comparing the one or more key words to the real time data to determine whether the real time data is relevant to the item of interest.

4. The method of claim 1, wherein the information includes at least one of real time audio broadcasts, real time video broadcasts, and real time text streams.

5. The method of claim 1, wherein the information includes real time audio broadcasts and real time video broadcasts.

6. The method of claim 5, wherein the real time data includes transcriptions of the real time audio broadcasts and the real time video broadcasts.

7. The method of claim 1, wherein the alerting the user includes at least one of:
placing a telephone call to the user,
sending an e-mail to the user,
sending a page to the user,
sending an instant message to the user, and
sending a facsimile to the user.

8. The method of claim 1, wherein the alerting the user includes:
generating an alert notification, and
sending the alert notification to the user.

9. The method of claim 8, further comprising:
receiving, from the user, a request for additional information relating to the alert notification, and
sending the additional information to the user.

10. The method of claim 8, wherein the sending the alert notification includes:
transmitting the alert notification to the user at approximately a same time at which the real time data is obtained.

11. The method of claim 8, wherein the alert notification includes the information in one of the media formats in which the information was created.

12. A system for alerting a user in real time when an item of interest is detected, comprising:
means for obtaining a user profile that relates to the item of interest;
means for receiving real time data, the real time data including textual representations of information created in a plurality of media formats;
means for determining relevance of the real time data to the item of interest based on the user profile; and
means for sending an alert to the user when the real time data is determined relevant.

13. A real-time alerting system, comprising:
collection logic configured to:
receive real time data, the real time data including textual representations of information created in a plurality of media formats; and
notification logic configured to:
obtain a user profile that identifies one or more subjects of data of which a user desires to be notified,
determine relevance of the real time data received by the collection logic to the one or more subjects based on the user profile, and
send an alert to the user when the real time data is determined relevant.

14. The system of claim 13, wherein the user profile includes one or more key words relating to the one or more subjects.

15. The system of claim 14, wherein when determining relevance of the real time data, the notification logic is configured to:
compare the one or more key words to the real time data to determine whether the real time data is relevant to the one or more subjects.

16. The system of claim 13, wherein the information includes at least one of real time audio broadcasts, real time video broadcasts, and real time text streams.

17. The system of claim 13, wherein the information includes real time audio broadcasts and real time video broadcasts.

18. The system of claim 17, wherein the real time data includes transcriptions of the real time audio broadcasts and the real time video broadcasts.

19. The system of claim 13, wherein when sending an alert, the notification logic is configured to cause at least one of a telephone call to be placed to the user, an e-mail to be sent to the user, a page to be sent to the user, an instant message to be sent to the user, and a facsimile to be sent to the user.

20. The system of claim 13, wherein when sending an alert, the notification logic is configured to:
generate an alert notification, and
send the alert notification to the user at approximately a same time at which the real time data is received.

21. The system of claim 13, wherein the notification logic is further configured to:
receive, from the user, a request for additional information relating to the alert, and
send the additional information to the user.

22. The system of claim 21, wherein the additional information includes the textual representation of the information.

23. The system of claim 21, wherein the additional information includes the information in one of the media formats in which the information was created.

24. The system of claim 13, wherein the alert includes the information in one of the media formats in which the information was created.

25. A computer-readable medium that stores instructions which when executed by a processor cause the processor to perform a method for alerting a user in real time when a topic of interest is detected, the computer-readable medium comprising:
instructions for obtaining a user profile that identifies one or more topics of which a user desires to be notified;
instructions for acquiring real time data items corresponding to information created in a plurality of media formats;
instructions for determining relevance of the real time data items to the one or more topics based on the user profile; and
instructions for alerting the user when one or more of the real time data items are determined relevant.

26. An alerting system, comprising:
one or more audio indexers configured to:
capture real time audio broadcasts, and
transcribe the audio broadcasts to create a plurality of transcriptions; and
alert logic configured to:
receive a user profile that identifies one or more topics of which a user desires to be notified,
receive the transcriptions from the one or more audio indexers,
determine relevance of the transcriptions to the one or more topics based on the user profile, and
alert the user when one or more of the transcriptions are determined relevant.

27. The alerting system of claim 26, wherein the alert logic is configured to alert the user at approximately a same time at which the real time audio broadcasts are captured.

28. An alerting system, comprising:
one or more video indexers configured to:
capture real time video broadcasts, and
transcribe audio from the video broadcasts to create a plurality of transcriptions; and
alert logic configured to:
receive a user profile that identifies one or more topics of which a user desires to be notified,
receive the transcriptions from the one or more video indexers,
determine relevance of the transcriptions to the one or more topics based on the user profile, and
alert the user when one or more of the transcriptions are determined relevant.

29. The alerting system of claim 28, wherein the alert logic is configured to alert the user at approximately a same time at which the real time video broadcasts are captured.

30. An alerting system, comprising:
one or more text indexers configured to receive real time text streams; and
alert logic configured to:
receive a user profile that identifies one or more topics of which a user desires to be notified,
receive the text streams from the one or more text indexers,
determine relevance of the text streams to the one or more topics based on the user profile, and
alert the user when one or more of the text streams are determined relevant.

31. An alerting system, comprising:
one or more audio indexers configured to:
capture real time audio broadcasts, and
transcribe the audio broadcasts to create a plurality of audio transcriptions;
one or more video indexers configured to:
capture real time video broadcasts, and
transcribe audio from the video broadcasts to create a plurality of video transcriptions;
one or more text indexers configured to receive real time text streams; and
alert logic configured to:
receive a user profile that identifies one or more topics of which a user desires to be notified,
receive the audio transcriptions from the one or more audio indexers, the video transcriptions from the one or more video indexers, and the text streams from the one or more text indexers,
determine relevance of the audio transcriptions, the video transcriptions, and the text streams to the one or more topics based on the user profile, and
alert the user when at least one of the audio transcriptions, the video transcriptions, and the text streams is determined relevant.
